(19) United States
(12) Patent Application Publication
(10) Pub. No.: US 2025/0276630 A1
(43) Pub. Date: Sep. 4, 2025

(54) Portable Tailgate Lift Platform

(71) Applicant: Zoran Martinovski, Calgary (CA)

(72) Inventor: Zoran Martinovski, Calgary (CA)

(21) Appl. No.: 18/591,867

(22) Filed: Feb. 29, 2024

(51) Int. Cl. B60P 1/44; B65G 67/04

(52) U.S. Cl. CPC B60P 1/4435; B60P 1/4471; B60P 1/4485; B65G 67/04

(57) ABSTRACT

A portable tailgate lift platform for lifting and lowering heavy items or home appliances to and from pickup truck cargo bed that is mounted on the open truck tailgate and secured in place by attachment to the anchor points supplied in the truck cargo bed. Does not require any truck alteration. The lift platform operation between ground and tailgate level is by manual or electric winch provided with the lift. Mounting or removal for storage of the tailgate lift platform is easily done by a single person. For transportation to new location the lift is simply rotated from vertical position at the end of the tailgate and pushed into truck cargo bed. Storage in vertical position next to a wall requires minimal space with loading platform folded upright.

### TECHNICAL FIELD

This disclosure relates to pickup truck cargo lifts, but more specifically to portable lift platform apparatus that can be mounted on the tailgate or stored away with one person, not requiring truck alteration.

### BACKGROUND OF THE INVENTION

Pickup trucks are popular vehicles for transporting bulk items, equipment, building materials, farm supplies or appliances in cargo beds that are parallel to the ground but too high above the ground for average single person to load heavy items to this elevated surface.

Several lifts were developed for loading heavy items to pickup truck beds. Most of them are of heavy construction not to be moved with the truck to unloading location or require some form of truck alteration, such as tailgate removal, or attachment to the truck hitch.

None of the above employ the use of a tailgate to support portable and foldable lift platform that can be easily mounted on the tailgate with one person, folded to the truck bed for use at new location and removed from the truck for storage without any alterations to the truck. All of this is possible with the present invention.

### SUMMARY OF THE INVENTION

The present invention represents portable and foldable lift platform apparatus and method of mounting the lift on the edge of an open pickup truck tailgate with a, preferably, manual winch for lifting and lowering loading platform assembly parallel to the truck bed. The lift is secured against overturning or sliding off the tailgate with flexible members (steel ropes or chains) connected to the standard anchor points at the sides of the truck bed. The lift brackets projecting in the front of the tailgate edge prevent sliding into the truck bed.

The heavy item can be dollied onto the lift platform or from the platform to the truck bed.

The size of this foldable loading platform is meant to accommodate, as a minimum, standard home appliance.

The lift apparatus comprises two independent assemblies. The first is stationary, with a winch and two vertical members perpendicular to the truck bed, mounted on the edge of the open tailgate with brackets in front of the edge preventing movement of the assembly into the truck bed. Overturning and sliding off the tailgate is secured by steel ropes or chains connecting stationary assembly to the truck bed anchors. The second assembly, with loading platform parallel to the truck bed and wheels attached to the assembly framing, moves up and down the first assembly vertical members under the winch action. The wheels are running on the opposite sides of the vertical members of the stationary assembly to resist overturning caused by the platform load while keeping the loading platform parallel to the truck bed.

This movement is achieved by changing the length of the steel rope that runs from the winch attached to the top of the vertical member of the stationary assembly, under the second assembly, to the anchor point on the other vertical member of the stationary assembly. Guide wheels attached to the bottom corners of the moving assembly framing accommodate rope movement and transfer weight from the platform to the rope, and, ultimately, to the stationary assembly resting on the tailgate.

For transportation to new location, the loading platform assembly is winched to the tailgate level, loading platform folded from horizontal to vertical position and complete lift assembly simply rotated around supporting points at the edge of the tailgate and pushed into truck bed. Disconnect from the truck anchor points is not required.

The main objective of the present invention is the provision of a lift for loading heavy items to pickup truck bed that can be installed on the truck without need for any truck alteration.

Another advantage of the present invention is that installation is not permanent, it is mounted and removed as needed.

Another advantage of the present invention is that single person can easily mount, use and remove the lift.

Another advantage of the present invention that is easily transportable inside the track bed.

Another advantage of the present invention is that it can be stored as a single or two separate assemblies in upright position next to the wall requiring very small space.

Another advantage of the present invention is simplicity of construction with cost affordable to non-professional user.

The above summary described only preferable concept for construction and setup of the presented invention. Other embodiments can achieve the same result, some of which will be mentioned in the detailed descriptions that follow. Variations and modifications to the present invention will be obvious to those skilled in the art and could be made without departing from the scope of the invention set forth in the claims as well as in appended drawings and the detailed descriptions further in the text.

### BRIEF DESCRIPTION OF THE DRAWINGS

The accompanying drawings that depict several embodiments of the present invention are made part of the specification to explain, together with the detailed descriptions, the principals of the invention. The illustrations provided on the drawings are presenting preferred embodiments of the invention and shall not be construed as limiting the invention.

Those skilled in the art will appreciate that illustrations on the drawings present simplified perspective views that are preferably made for clarity and ease of understanding of principals rather than adhering to the strict drafting standards or scale.

FIG. 1, is a perspective view of a pickup truck with tailgate open with embodiment of the portable tailgate lift according to the present invention mounted on the pickup truck tailgate with loading platform assembly at ground level and, in phantom line, elevated to the truck tailgate position.

FIG. 2, Is a perspective view of the portable tailgate lift of FIG. 1. with loading platform assembly in lower position at ground level.

FIG. 3, is a section view looking down on the framing of loading platform assembly shown on FIG. 2.

FIG. 4, is a perspective view of the portable tailgate lift of FIG. 1. with loading platform assembly elevated to tailgate position.

FIG. 5, is a perspective view of the portable tailgate lift loading platform assembly

FIG. 6, is a perspective view of framing with wheels of the loading platform assembly shown on FIG. 5.

FIG. 7, is a perspective view of the loading platform with ropes, part of the assembly shown on FIG. 5.

FIG. 8, is a perspective view of the portable tailgate lift stationary assembly in parking position

FIG. 9, is a perspective view of the portable tailgate lift loading platform assembly in parking position with the platform folded upright.

FIG. 10, is a perspective view of the portable tailgate lift complete assembly in parking position with the loading platform folded upright.

### DETAILED DESCRIPTION AND SPECIFICATION OF THE INVENTION

Illustrated preferred embodiments are disclosed with reference to the drawings. The structural and other engineering details and function disclosed are not to be interpreted as limiting but rather representative of preferred example which could be embodied in various alternative forms with those skilled in the art.

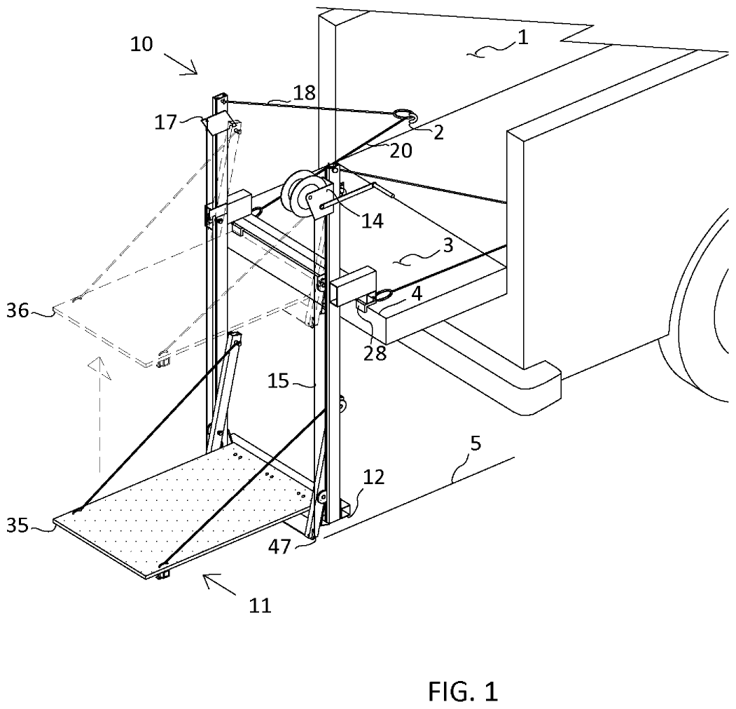

Referring to FIG. 1,: The present invention, portable tailgate lift platform, is shown mounted on the truck tailgate edge 4 as a complete assembly consisting of a stationary assembly 10 and loading platform assembly 11 presented in both lower position 35 at ground 5 and upper position 36, just above tailgate 3 level. Stability of the complete assembly is provided by brackets 28 that transfer vertical and horizontal forces from the stationary assembly 10 to the tailgate edge 4 and tension members 18 that transfer forces coming from overturning resistance to anchor points 2 that are supplied as a standard feature on the truck bed sides 1. To prevent the lift support brackets 28 from sliding off the tailgate edge 4, tension members 20 are connecting brackets 28 to the anchor points 2.

Moving of the loading platform assembly 11 up and down stationary assembly 10 is achieved by winch 14 retracting or extending steel rope 15 that runs from the winch 14, around assembly 11 guide wheels 47 to the anchor 17 on the other side of stationary assembly 10.

Bottom edge 12 of assembly 10 is above grade level 5 so that lifted weight is transferred to the tailgate edge 4 rather than the ground. This prevents uneven ground from interfering with lifting operation. Tailgate 3 and ground 5 should be substantially horizontal while using the lift with the slope not more than 4% in any direction to avoid need for stronger components and special safety considerations. Slope difference between tailgate 3 and ground 5 should be less than 2%.

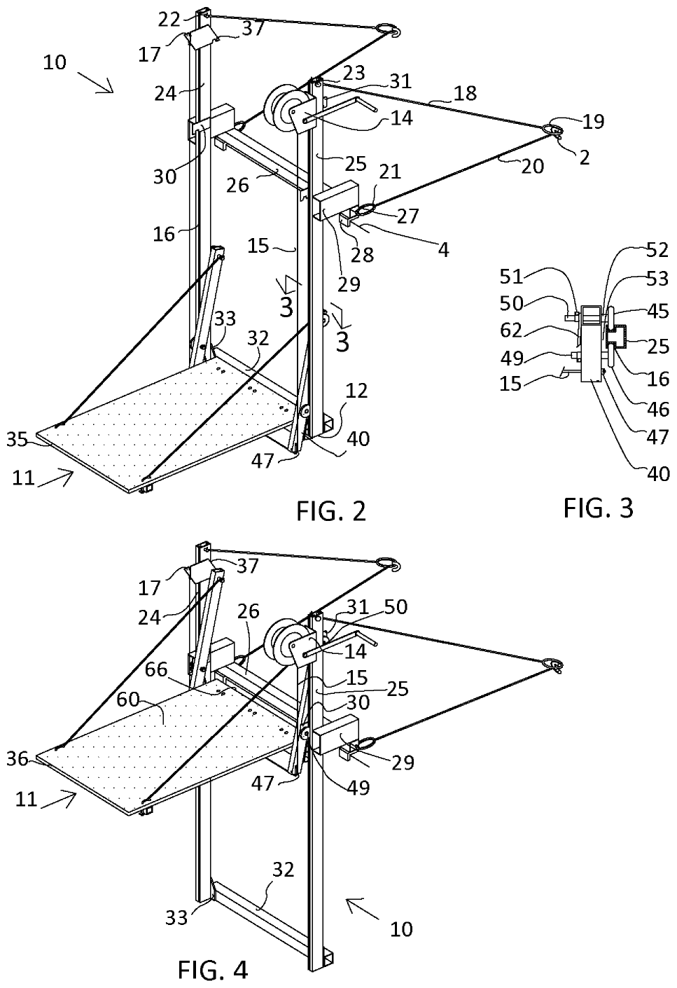

Referring to FIG. 2,: The present invention is presented as a complete assembly with loading platform 11 in lower position 35. Stationary assembly 10 structure is made of vertical aluminum tubular members 24 and 25, rigidly connected with two horizontal cross members 26 and 32. Cross member 32 is connected with vertical members 24 and 25 near bottom 12 with connector plates 33 while cross member 26 is connected to vertical members 24 and 25 with short tubular members 29. Cross member 26 is made offset from vertical members 24 and 25 to accommodate passage of the loading platform assembly 11. Members 29 are made as rectangular tubes for torsional stiffness but could be triangular tubes or other stiff extruded aluminum shapes or thick angles.

Stationary assembly 10 is secured against overturning caused by loading platform 11 with flexible tension members 18 that connect pin with cotter pin 22 on the top of vertical members 24 and 25 to the truck anchor points 2. Pin head 23 is positioned on the outside of vertical members for ease of installation. Tension members 18 are made with carabiner or snap hook 19 at the end for one hand connecting to the anchor points 2.

Brackets 28 fixed at the ends of cross member 26 provide resting points for stationary assembly 10 on the edge of tailgate 4. Brackets 28 transfer the weight of the complete assembly to the edge of tailgate 4 as well as horizontal reaction directed towards the edge 4 that is coming from loading assembly 11 overturning moment. The brackets are made as angles with one leg connected to the bottom of cross member 26 and the other leg projecting in the front of the edge 4 to resist the pushing horizontal reaction. To prevent brackets 28 from sliding off the tailgate edge 4, holes 27 are made in member 26 above the brackets 28 for connecting flexible member 20 end carabiner 21. The carabiner or snap hook 19 on the other end of the members 20 connects to the truck anchor points 2 so that tension members 20 prevent brackets 28 and thus the stationary assembly 10 from sliding off the tailgate edge 4.

Function of the present invention, portable tailgate lift platform, is made possible by, preferably, manual winch 14 attached near the top of vertical member 25. Plastic-coated steel rope 15 runs from the winch 14 under the platform assembly 11 guide wheels 47, to the anchor bracket 17 on the other vertical member 24 of the stationary assembly 10. Winching rope 15 is lifting platform assembly 11 from lower position 35 to the final upper position 36, shown on FIG. 4, or the opposite way, lowering from the position 36 to the position 35. Mechanics of this movement maintained by channel guides 16 on vertical members 24 and 25 is explained in FIG. 3,. Brackets 30 attached to vertical members 24 and 25 as well as 31 and 37 limit the movement of the platform assembly 11, as further explained in FIG. 4,.

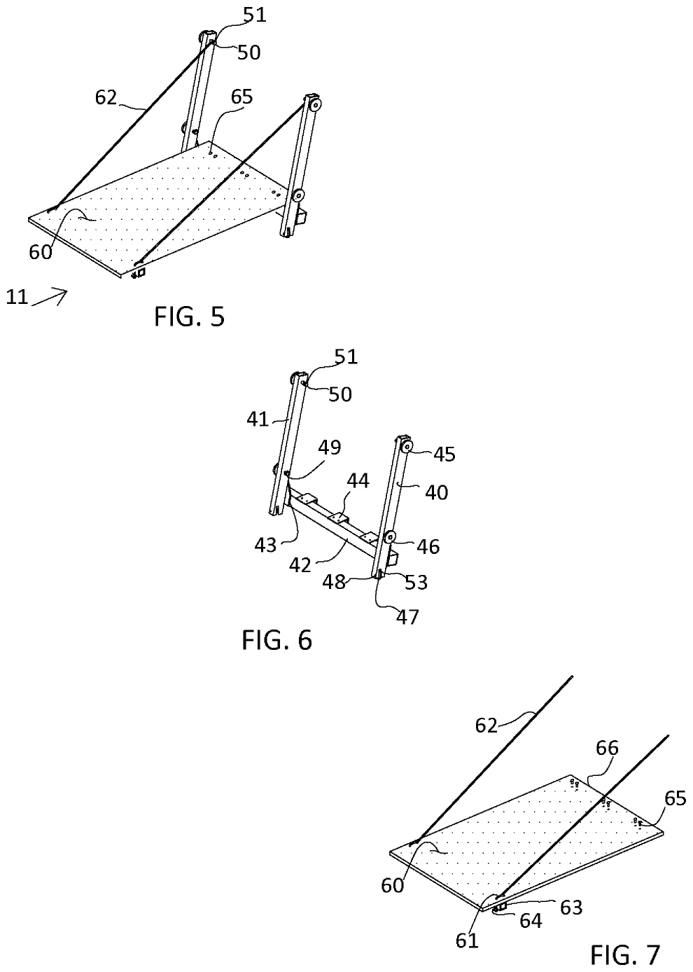

Referring to FIG. 3,: Section 3 indicated on FIG. 2. cutting through vertical member 25 is shown with main parts relevant to the movement mechanics. Other parts are not shown for clarity. The same section cutting through member 24 would be a mirror image of the presented section. Vertical member 25 geometry is shown (24 is the same) as aluminum extrusion tube with guide channels 16 that are shaped slightly wider than wheels 45 and 46 to prevent jamming of the wheels. The sides of the channels 16 provide resistance against wheel side travel. Wheels 45 and 46 are made plastic to reduce travel friction and with steel bearings to resist pressure and side loads coming from travel of the loaded platform assembly 11. Wheel steel shafts 49 and 50 are fixed through frame tube 40 and secured with steel clamps 51. Shaft diameter 52 on the other side of the tube 40 is larger than the rest of the shaft, similar to the standard garage door wheel shafts, to prevent movement in the other direction. Frame tube 40 is away from the face of vertical member 25 with enough gap 53 to pass brackets 30 and 31 when traveling from the bottom position 35 to the top position 36, as shown in FIG. 3, and FIG. 4,. Aluminum frame tube 40 is resistant to the torsion imposed by opposing wheel forces from shafts 49 and 50 going through the tube. Shaft 50 of the top wheel 45 is made longer to accept anchoring of tension member 62 that connects load platform 60 to the shaft, as shown on FIG. 5,. Steel clamp 50 prevents tension member 62 from sliding off of the shaft 50. The whole moving loaded platform assembly 11 weight is resting on the rope 15 running around guide wheels 47 that are fixed at the bottom of frame member 40 and 41, as shown on FIG. 6,.

Positioning of the loading platform assembly 11 wheels 45 and 46 in the guide channels 16 is done by bringing the assembly inclined through vertical plane between members 24 and 25 until top wheels 45 are aligned with channels 16 on the back of the vertical members and than rotating to put bottom wheels 46 in the front channels 16. Rope 15 is then removed under stationary assembly 10 bottom 12 and positioned over guide wheels 47. This mounting of the moving platform assembly 11 is easily done by a single person.

Referring to FIG. 4,: The present invention is presented as a complete assembly with loading platform assembly 11 in upper position 36 with edge 66 of the platform 60 just above the top of cross member 26. This position is held by locked winch 14 with steel rope 15 distributing the weight force from wheels 47 of the loaded platform assembly 11 evenly between winch 14 and anchor bracket 17. Lifted load should be positioned along the center line of platform 60. Any forces from small loading eccentricity (within 10% of the platform 60 width) is transferred as a pair of opposing horizontal forces to each of vertical members 24 and 25 through rigidity of the platform assembly 11 framing shown on FIG. 6,. Cross members 26 and 32 rigidly connected to vertical members 24 and 25 with corner plates 33 and tube members 29 provide rigidity to stationary assembly 10 framing required to resist these forces.

To prevent movement of the platform assembly 11 in upper position 36 during loading/unloading, brackets 30 are provided to hold bottom wheels shafts 49 and brackets 31 and 37 to hold top wheels shafts 50.

Referring to FIG. 5,: Moving platform assembly 11 is presented in an open position. Loading platform 60 is connected to the assembly framing with flexible steel tension ropes 62 at the front and carriage bolts 65 at the back. As indicated on FIG. 3, steel ropes 62 are connected to steel shafts 50 at the top of the framing and secured with steel clamps 51. Carriage bolts 65 are used for the shallow, oval head that will not interfere with the load on the platform 60.

Referring to FIG. 6,: Moving platform assembly 11 framing is presented. Upright aluminum tube members 40 and 41 are rigidly connected with aluminum tube cross member 42. Corner plates 43 are provided to make connection between the members rigid. Three steel hinges 44 are attached to the back of cross member 42 to provide support for loading platform 60 and accommodate folding of the loading platform when not in use. The hinges are connected with platform 60 with carriage bolts 65 shown on FIG. 5, and FIG. 6,.

Lower wheels 46 and top wheels 45 are fixed on the outside of upright members 40 and 41 with steel shafts 49 and 50 going through the tubes as shown in FIG. 3,. Steel clamps 51 prevent side wheel movement. Guide wheels 47 are positioned at the bottom outside corner of the upright members 40 and 41, projecting outside of the member face through slot 53 and open bottom to accommodate steel rope 15 movement around the corner. FIG. 3, shows the detail. Wheels 47 are made inclined to the upright members axis with shaft 48 going through the walls of the tube. This is to align the guide wheel 47 with vertical rope 15 when moving assembly 11 is mounted on stationary assembly 10.

Referring to FIG. 7,: Moving platform assembly 11 platform parts are shown. Platform 60 is made from light, strong material, structural plywood, plastic or aluminum. Front of the platform is supported on aluminum tube 63 to reduce deflection under loads unless platform 60 material is made strong enough to hold the load on its own. Plate 64 under tube 63 is held by “U” bolt 61, clamping tube 63 to the bottom of platform 60. At the same time, “U” bolt 61 is serving as an anchor for flexible member 62 that supports the front of platform 60. Steel carriage bolts 65 are used to connect platform 60 near the back edge 66 to hinges 44 shown on FIG. 6,.

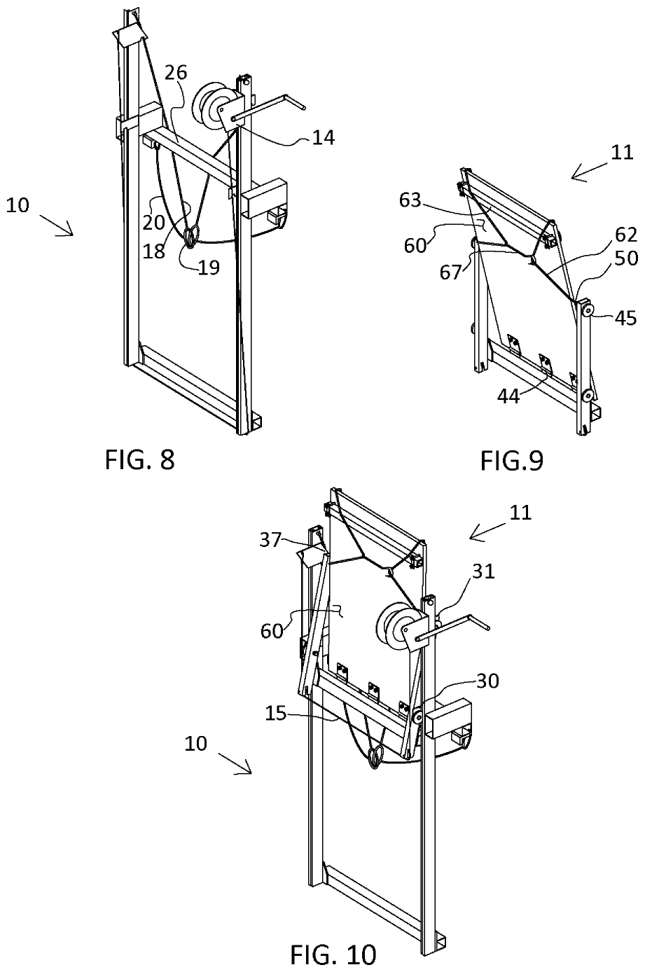

Referring to FIG. 8,: Stationary assembly 10 is shown in storage position. Rope 15 is positioned over bottom edge 12 and slightly tensioned with winch 14 to prevent movement of the rope. Flexible members 18 and 20 are secured with snap hooks 19 behind cross member 26. This is made for convenience of resting assembly 10 on the wall and ease of mounting the assembly back to the truck tailgate.

Referring to FIG. 9,: Moving platform assembly 11 is shown in storage position. Platform 60 is rotated about hinges 44 to rest on shafts 50. Flexible members 62 wrapped around top of platform 60 over tube 63 are connected with elastic bungee cord 67 to keep platform 60 in upper position. This is made for convenience of resting assembly 11 on the wall and ease of mounting the assembly back to assembly 10.

Referring to FIG. 10,: The present invention, portable tailgate lift platform, is shown as a complete assembly in storage position. Moving assembly 11 is mounted on stationary assembly 10 that is in storage position and, by winching rope 15, brought to brackets 30, 31 and 37 that lock assembly 11 in this upper position. Platform 60 is then folded to assembly 11 storage position shown in FIG. 9, to make the portable tailgate lift platform complete assembly ready for storage.

This complete assembly can be than stored next to a wall or mounted back to a truck tailgate with only one person. It is up to the user preference to store or mount this portable tailgate lift platform as a complete assembly presented in this FIG. 10, or as a separate assemblies presented in FIG. 8, and FIG. 9,.

The present invention details have been described with reference to preferred embodiments although other embodiments can achieve the same results. Numerous variations and modifications of the present invention could be made by those skilled in the art without departing from the scope of the present invention set forth in the claims. Thus, it is intended that the present invention covers all these possible modifications and variations of this invention provided they come within scope of the appended claims and their equivalents.

What is claimed is:

1. Portable apparatus for lifting and lowering items to and from pickup truck cargo bed that is mounted on the open truck tailgate and secured in place by attachment to anchor points in the truck cargo bed comprising:
A stationary assembly with two rigid framing members at cross distance wider than lifted items, starting near ground, projecting above the open truck tailgate, supported on the truck tailgate and secured from overturning or sliding by tension members connected to the anchor points in the truck cargo bed;
A loading platform assembly with supporting rigid framing that mounts on the stationary assembly two framing members and moving up and down these two members on wheels fixed in the supporting rigid framing while maintaining the loading platform parallel to the truck cargo bed
A winch, manual or electric, attached to one of the stationary assembly rigid framing members for lifting and lowering loading platform assembly by retracting or extending steel rope that runs from the winch, around loading platform assembly rigid framing bottom to the anchor on the other stationary assembly framing member.
